(19) United States
(12) Patent Application Publication
(10) Pub. No.: US 2026/0250533 A1
(43) Pub. Date: Aug. 27, 2026

(54) Radiation Curable Ink Composition For Ink Jet

(71) Applicant: SEIKO EPSON CORPORATION, Tokyo (JP)

(72) Inventors: Masakazu ORII, Matsumoto (JP); Toru SAITO, Yamagata (JP); Midori SEKINE, Matsumoto (JP); Yusuke FUJISAWA, Shiojiri (JP)

(21) Appl. No.: 19/549,239

(22) Filed: Feb. 25, 2026

(30) Foreign Application Priority Data
Feb. 26, 2025 (JP) 2025-029476

(51) Int. Cl. C09D 11/38; C08K 3/04; C08K 5/23; C08K 5/3435; C08K 5/5313

(52) U.S. Cl. CPC C09D 11/38; C08K 3/04; C08K 5/235; C08K 5/3435; C08K 5/5313

(57) ABSTRACT

A radiation curable ink composition for ink jet according to one embodiment of the present disclosure contains a polymerizable compound and a photopolymerization initiator, where the photopolymerization initiator includes (2,4,6-trimethylbenzoyl)bis(p-tolyl)phosphine oxide, a content of the (2,4,6-trimethylbenzoyl)bis(p-tolyl)phosphine oxide is 3% by mass or more with respect to a total amount of the ink composition, the polymerizable compound includes a monofunctional polymerizable compound, and a content of the monofunctional polymerizable compound is 70% by mass or more with respect to a total amount of the polymerizable compound.

The present application is based on, and claims priority from JP Application Serial Number 2025-029476, filed Feb. 26, 2025, the disclosure of which is hereby incorporated by reference herein in its entirety.

### BACKGROUND

### 1. Technical Field

The present disclosure relates to a radiation curable ink composition for ink jet.

### 2. Related Art

An ink jet recording method can record a high-definition image with a relatively simple apparatus and is rapidly developed in various fields. Among them, various studies were made on the ink composition for ink jet that is cured by irradiation with radiation.

For example, JP-A-2021-155464 describes a radiation curable ink jet composition containing ethyl (2,4,6-trimethylbenzoyl)phenyl phosphinate, in which a content of a monofunctional monomer is 90% by mass or more with respect to a total amount of a polymerizable compound.

However, there is a problem in that it is necessary to achieve both excellent adhesiveness of the coating film and excellent storage stability of the ink composition in the high temperature and low temperature environments.

### SUMMARY

According to one aspect of a radiation curable ink composition for ink jet according to the present disclosure, the radiation curable ink composition for ink jet contains a polymerizable compound and a photopolymerization initiator, where the photopolymerization initiator includes (2,4,6-trimethylbenzoyl)bis(p-tolyl)phosphine oxide, a content of the (2,4,6-trimethylbenzoyl)bis(p-tolyl)phosphine oxide is 3% by mass or more with respect to a total amount of the ink composition, the polymerizable compound includes a monofunctional polymerizable compound, and a content of the monofunctional polymerizable compound is 70% by mass or more with respect to a total amount of the polymerizable compound.

### BRIEF DESCRIPTION OF THE DRAWINGS

FIG. 1 is a perspective view illustrating an example of a recording device.

FIG. 2 is Table 1 that shows the composition and evaluation results of the radiation curable ink composition for ink jet according to each example.

FIG. 3 is Table 2 that shows the composition and evaluation results of the radiation curable ink composition for ink jet according to each example and each comparative example.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing the gist of the present disclosure. It is noted that not all of the configurations described below are essential configurations of the present disclosure.

In the present specification, a numerical value range indicated by using “to” means a range including numerical values described before and after “to” as a lower limit value and an upper limit value.

In the present specification, “(meth)acrylic” means acrylic or methacrylic, and “(meth)acrylate” means acrylate or methacrylate.

### 1. RADIATION CURABLE INK COMPOSITION FOR INK JET

A radiation curable ink composition for ink jet according to one embodiment of the present disclosure contains a polymerizable compound and a photopolymerization initiator, where the photopolymerization initiator includes (2,4,6-trimethylbenzoyl)bis(p-tolyl)phosphine oxide, a content of the (2,4,6-trimethylbenzoyl)bis(p-tolyl)phosphine oxide is 3% by mass or more with respect to a total amount of the ink composition, the polymerizable compound includes a monofunctional polymerizable compound, and a content of the monofunctional polymerizable compound is 70% by mass or more with respect to a total amount of the polymerizable compound.

In a recorded matter obtained by using a radiation curable ink composition for ink jet (hereinafter, may be simply referred to as “ink composition” or “ink”), it is desirable that a coating film obtained by curing the ink has excellent adhesiveness.

In addition, as a photopolymerization initiator to be used in the radiation curable ink composition for ink jet, an acylphosphine oxide-based photopolymerization initiator such as ethyl (2,4,6-trimethylbenzoyl)phenyl phosphinate (TPO-L, also known as ethylphenyl (2,4,6-trimethylbenzoyl) phosphinate) or bis(2,4,6-trimethylbenzoyl)-phenylphosphine oxide (819) is known. Recently, it was revealed that an ink containing ethyl (2,4,6-trimethylbenzoyl)phenyl phosphinate has deteriorated storage stability when allowed to stand in a high temperature environment, and an ink containing bis(2,4,6-trimethylbenzoyl)-phenylphosphine oxide has deteriorated storage stability when allowed to stand in a low temperature environment.

This is presumed to be because ethyl (2,4,6-trimethylbenzoyl)phenyl phosphinate (TPO-L) is a liquid type photopolymerization initiator, and the stability thereof is likely to deteriorate in a high temperature environment because the amount of impurities is large as compared with the powder type. In addition, it is presumed that bis(2,4,6-trimethylbenzoyl)-phenylphosphine oxide (819) has a relatively large molecular weight and low solubility in ink, and thus it is likely to be precipitated in a low temperature environment, and the stability thereof is likely to be deteriorated.

On the other hand, the radiation curable ink composition for ink jet according to the present embodiment contains a predetermined amount or more of (2,4,6-trimethylbenzoyl)bis(p-tolyl)phosphine oxide as a photopolymerization initiator and a predetermined amount or more of a monofunctional polymerizable compound, and thus it is possible to achieve both excellent adhesiveness of the coating film and excellent storage stability of the ink composition in the high temperature and low temperature environments.

It is noted that the “radiation curable ink composition for ink jet” according to the present embodiment is an ink composition that is used by being ejected from an ink jet head by an ink jet method. Hereinafter, a radiation curable ink composition will be described as one embodiment of the radiation curable ink composition for ink jet. However, the composition according to the present embodiment may be a composition other than the ink composition, for example, a composition that is used for 3D modeling.

In addition, the radiation curable ink composition for ink jet according to the present embodiment is cured by irradiation with radiation. Examples of the radiation include ultraviolet rays, electron rays, infrared rays, visible light, X-rays, active energy rays, and the like. As the radiation, the ultraviolet rays are preferable from the viewpoint that a radiation source is easily obtained and widely used, and from the viewpoint that a material suitable for curing by radiation with ultraviolet rays is easily obtained and widely used.

Hereinafter, each component contained in the radiation curable ink composition for ink jet according to the present embodiment will be described.

### 1.1 Polymerizable Compound

The radiation curable ink composition for ink jet according to the present embodiment contains a polymerizable compound, the polymerizable compound includes a monofunctional polymerizable compound, and the content of the monofunctional polymerizable compound is 70% by mass or more with respect to a total amount of the polymerizable compound.

The “polymerizable compound” refers to a compound containing a polymerizable functional group, and it may be a monomer or may be a polymer. It is noted that the “polymerizable functional group” refers to a group involved in a polymerization reaction.

Examples of the polymerizable compound include a monofunctional polymerizable compound having one polymerizable functional group and a polyfunctional polymerizable compound having a plurality of polymerizable functional groups. One kind of each polymerizable compound may be used alone, or two or more kinds thereof may be used in combination.

From the viewpoint of excellent adhesiveness, the content of the polymerizable compound is preferably 30% by mass or more, more preferably 50% by mass or more, still more preferably 70% by mass or more, and particularly preferably 80% by mass or more, with respect to the total amount of the ink composition. In addition, the upper limit of the content of the polymerizable compound is not particularly limited; however, it is preferably 99% by mass or less, more preferably 95% by mass or less, and still more preferably 90% by mass or less with respect to the total amount of the ink composition.

### 1.1.1 Monofunctional Polymerizable Compound

The polymerizable compound includes a monofunctional polymerizable compound. The monofunctional polymerizable compound is not particularly limited; however, examples thereof include an aromatic group-containing polymerizable compound, a nitrogen-containing monofunctional polymerizable compound, a hydroxyl group-containing monofunctional polymerizable compound, a hydrocarbon ring-containing monofunctional polymerizable compound, an ether ring-containing monofunctional polymerizable compound, an aliphatic group-containing polymerizable compound, a urethane acrylate, and the like. In addition, other monofunctional polymerizable compounds may be included as necessary. It is noted that the monofunctional polymerizable compounds other than those described above are not particularly limited; however, a monofunctional polymerizable compound having a polymerizable functional group, particularly a polymerizable functional group having an unsaturated double bond between carbon atoms, which are publicly known in the related art, can be used. One kind of monofunctional polymerizable compound may be used alone, or two or more kinds thereof may be used in combination.

The content of the monofunctional polymerizable compound is 70% by mass or more with respect to the total amount of the polymerizable compound. When the content of the monofunctional polymerizable compound is in the above-described range, the adhesiveness of the coating film can be made excellent. The content of the monofunctional polymerizable compound is 70% by mass or more with respect to the total amount of the polymerizable compound; however, it is more preferably 75% by mass or more, still more preferably 80% by mass or more, and particularly preferably 85% by mass or more. Further, the content of the monofunctional polymerizable compound may be 90% by mass or more or may be 95% by mass or more with respect to the total amount of the polymerizable compound.

In addition, the upper limit of the content of the monofunctional polymerizable compound is not particularly limited; however, it is preferably 99% by mass or less, more preferably 95% by mass or less, and still more preferably 90% by mass or less with respect to the total amount of the polymerizable compound.

In particular, when the content of the monofunctional polymerizable compound is 85% by mass or more with respect to the total amount of the polymerizable compound, not only adhesiveness but also extensibility can be made excellent, which is preferable.

In addition, from the same viewpoint, the content of the monofunctional polymerizable compound is preferably 50% by mass or more, more preferably 558 by mass or more, still more preferably 60% by mass or more, and even still more preferably 65% by mass or more with respect to the total amount of the ink composition. The upper limit of the content of the monofunctional polymerizable compound is preferably 90% by mass or less, more preferably 85% by mass or less, and still more preferably 80% by mass or less with respect to the total amount of the ink composition.

### 1.1.1.1 Aromatic Group-Containing Monofunctional Polymerizable Compound

The monofunctional polymerizable compound may include an aromatic group-containing monofunctional polymerizable compound. The aromatic group-containing monofunctional polymerizable compound has a function of enhancing the solubility of the acylphosphine oxide-based photopolymerization initiator. Therefore, when the aromatic group-containing monofunctional polymerizable compound is included, it tends to be possible to suppress the precipitation of the photopolymerization initiator in a low temperature environment and to make the storage stability of the ink composition in a low temperature environment more excellent.

The aromatic group-containing monofunctional polymerizable compound is not particularly limited as long as it has an aromatic group; however, examples thereof include phenoxyethyl (meth)acrylate, benzyl (meth)acrylate, an alkoxylated 2-phenoxyethyl (meth)acrylate, an ethoxylated nonylphenyl (meth)acrylate, an alkoxylated nonylphenyl (meth)acrylate, p-cumylphenol EO-modified (meth)acrylate, and 2-hydroxy-3-phenoxypropyl (meth)acrylate.

Among these, one or more selected from phenoxyethyl (meth)acrylate and benzyl (meth)acrylate are preferable, one or more selected from benzyl acrylate (BZA) and phenoxyethyl acrylate (PEA) are more preferable, and phenoxyethyl acrylate (PEA) is further preferable. When such an aromatic group-containing monofunctional polymerizable compound is used, the solubility of the solid photopolymerization initiator at normal temperature tends to be further improved, and the storage stability of the ink composition in a low temperature environment tends to be capable of being further improved. In particular, when a solid acylphosphine oxide-based polymerization initiator or a solid thioxanthone-based polymerization initiator is used at normal temperature, the solubility thereof tends to be favorable. In addition, when phenoxyethyl (meth)acrylate is used, the odor tends to be capable of being further reduced.

When the aromatic group-containing monofunctional polymerizable compound is contained, the content thereof is preferably 3% by mass or more, and more preferably 10% by mass or more with respect to the total amount of the ink composition from the viewpoint of being able to further improve the storage stability of the ink composition in a low temperature environment. The upper limit of the content of the aromatic group-containing monofunctional polymerizable compound is not particularly limited; however, it is preferably 50% by mass or less, more preferably 40% by mass or less, and still more preferably 30% by mass or less, with respect to the total amount of the ink composition.

Here, when the photopolymerization initiator does not include bis(2,4,6-trimethylbenzoyl)-phenylphosphine oxide (819), it is preferable that the content of the aromatic group-containing monofunctional polymerizable compound is 40% by mass or less with respect to the total amount of the ink composition or the aromatic group-containing monofunctional polymerizable compound is not contained. In addition, when the photopolymerization initiator includes bis(2,4,6-trimethylbenzoyl)-phenylphosphine oxide (819), the content of the aromatic group-containing monofunctional polymerizable compound is preferably 108 by mass or more with respect to the total amount of the ink composition.

### 1.1.1.2 Nitrogen-containing Monofunctional Polymerizable Compound

The monofunctional polymerizable compound may include a nitrogen-containing monofunctional polymerizable compound. When the nitrogen-containing monofunctional polymerizable compound is included, the adhesiveness and curability, particularly to the PET base material, tend to be improved.

The nitrogen-containing monofunctional polymerizable compound is not particularly limited; however, examples thereof include nitrogen-containing monofunctional vinyl monomers such as 5-methyl-3-vinyl-oxazolidin-2-one (VMOX, also known as 3-vinyl-5-methyl-2-oxazolidinone), N-vinylcaprolactam (N-VC), N-vinylformamide, N-vinylcarbazole, N-vinylacetamide, and N-vinylpyrrolidone; nitrogen-containing monofunctional acrylate monomers such as acryloylmorpholine (ACMO); and nitrogen-containing monofunctional acrylic amide monomers such as (meth)acrylamide, N-hydroxymethyl (meth)acrylamide, diacetone acrylamide, N,N-dimethyl (meth)acrylamide, and dimethylaminoethyl acrylate benzyl chloride quaternary salt. Among these, one or more selected from 5-methyl-3-vinyl-oxazolidin-2-one (VMOX), N-vinylcaprolactam (N-VC), and acryloylmorpholine (ACMO) are preferable, and one or more selected from 5-methyl-3-vinyl-oxazolidin-2-one (VMOX) and acryloylmorpholine (ACMO) are more preferable. When such a nitrogen-containing monofunctional polymerizable compound is used, the adhesiveness and curability of the ink coating film tend to be further improved. In addition, 5-methyl-3-vinyl-oxazolidin-2-one (VMOX) has a lower viscosity than other nitrogen-containing monofunctional polymerizable compounds. Therefore, when 5-methyl-3-vinyl-oxazolidin-2-one (VMOX) is added, it is possible to lower the viscosity of the ink for ink jet while improving the adhesiveness and curability of the ink coating film.

When the nitrogen-containing monofunctional polymerizable compound is contained, the content thereof is preferably 5% to 50% by mass, more preferably 10% to 40% by mass, still more preferably 15% to 35% by mass, and even still more preferably 20% to 30% by mass, with respect to the total amount of the ink composition. When the content of the nitrogen-containing monofunctional polymerizable compound is in the above-described range, the adhesiveness and curability of the ink coating film tend to be further improved.

### 1.1.1.3 Hydroxyl Group-containing Monofunctional Polymerizable Compound

The monofunctional polymerizable compound may include a hydroxyl group-containing monofunctional polymerizable compound. When the hydroxyl group-containing monofunctional polymerizable compound is included, the adhesiveness and curability, particularly to the PET base material, tend to be improved.

The hydroxyl group-containing monofunctional polymerizable compound is not particularly limited; however, examples thereof include 2-hydroxyethyl (meth)acrylate, 2-hydroxypropyl (meth)acrylate, 3-hydroxypropyl acrylate, 2-hydroxybutyl (meth)acrylate, 4-hydroxybutyl (meth)acrylate, ethylene glycol monovinyl ether, diethylene glycol monovinyl ether, and 2-(meth)acryloyloxy-2-hydroxypropyl phthalate, where in particular, 4-hydroxybutyl acrylate (4-HBA) is more preferable. When such a hydroxyl group-containing monofunctional polymerizable compound is used, the adhesiveness and curability of the ink coating film tend to be further improved.

When the hydroxyl group-containing monofunctional polymerizable compound is contained, the content thereof is preferably 5% to 50% by mass, more preferably 10% to 40% by mass, still more preferably 10% to 30% by mass, and particularly preferably 15% to 25% by mass, with respect to the total amount of the ink composition. When the content of the hydroxyl group-containing monofunctional polymerizable compound is in the above-described range, the adhesiveness and curability of the ink coating film tend to be further improved.

### 1.1.1.4 Hydrocarbon Ring-containing Monofunctional Polymerizable Compound

The monofunctional polymerizable compound may include a hydrocarbon ring-containing monofunctional polymerizable compound, and more preferably contains a saturated hydrocarbon ring-containing monofunctional polymerizable compound. In particular, when the saturated hydrocarbon ring-containing monofunctional polymerizable compound is included, the adhesiveness to the PP base material or the PE base material tends to be further improved.

The hydrocarbon ring-containing monofunctional polymerizable compound is not particularly limited as long as it is a monomer having one or more saturated or unsaturated hydrocarbon rings not having aromaticity; however, examples thereof include monomers having a monocyclic hydrocarbon group such as tert-butylcyclohexyl acrylate (TBCHA), 3,3,5-trimethylcyclohexyl acrylate (TMCHA), and 2-(meth)acrylic acid-1, 4-dioxaspiro[4,5]dec-2-yl methyl; monomers having an unsaturated polycyclic hydrocarbon group, such as dicyclopentenyl acrylate and dicyclopentenyloxyethyl acrylate; and monomers having a saturated polycyclic hydrocarbon group, such as dicyclopentanyl acrylate and isobornyl acrylate (IBXA). Among these, a saturated hydrocarbon ring-containing monofunctional polymerizable compound is preferable, and one or more selected from tert-butylcyclohexyl acrylate (TBCHA), 3,3,5-trimethylcyclohexyl acrylate (TMCHA), and isobornyl acrylate (IBXA) are preferable. When such a hydrocarbon ring-containing monofunctional polymerizable compound, particularly a saturated hydrocarbon ring-containing monofunctional polymerizable compound, is used, the shrinkage rate during polymerization tends to be reduced, and the adhesiveness of the ink coating film tends to be further improved.

When the hydrocarbon ring-containing monofunctional polymerizable compound is contained, the content thereof is preferably 5% to 40% by mass, more preferably 10% to 35% by mass, and still more preferably 15% to 30% by mass, with respect to the total amount of the ink composition. When the content of the hydrocarbon ring-containing monofunctional polymerizable compound, particularly the content of the saturated hydrocarbon ring-containing monofunctional polymerizable compound, is in the above-described range, the shrinkage rate during polymerization tends to be further reduced, and the adhesiveness of the ink coating film tends to be further improved.

### 1.1.1.5 Ether Ring-Containing Monofunctional Polymerizable Compound

The monofunctional polymerizable compound may include an ether ring-containing monofunctional polymerizable compound. When an ether ring-containing monofunctional polymerizable compound is included, the adhesiveness of the ink coating film tends to be further improved.

The ether ring-containing monofunctional polymerizable compound is not particularly limited as long as it contains a cyclic ether skeleton such as tetrahydrofuran or tetrahydropyran; however, examples thereof include cyclic trimethylolpropane formal acrylate (CTFA), cyclic trimethylolpropane formal methacrylate, tetrahydrofurfuryl acrylate (THFA), and tetrahydrofurfuryl methacrylate, and among these, one or more selected from cyclic trimethylolpropane formal acrylate (CTFA) and tetrahydrofurfuryl acrylate (THFA) are preferable. When such an ether ring-containing monofunctional polymerizable compound is used, the odor tends to be reduced, and the adhesiveness of the ink coating film tends to be also improved.

When the ether ring-containing monofunctional polymerizable compound is contained, the content thereof is preferably 5% to 30% by mass and more preferably 5% to 20% by mass with respect to the total amount of the ink composition. When the content of the ether ring-containing monofunctional polymerizable compound is in the above-described range, the odor tends to be further reduced, and the adhesiveness of the ink coating film tends to be also capable of being further improved.

### 1.1.1.6 Aliphatic Group-Containing Polymerizable Compound

The monofunctional polymerizable compound may include an aliphatic group-containing polymerizable compound. The aliphatic group-containing polymerizable compound is not particularly limited; however, examples thereof include a polymerizable compound represented by Formula (2).

H₂C═CR⁴—CO—O—R⁵ (2)

(In the formula (2), R⁴ represents a hydrogen atom or a methyl group, and R⁵ represents a linear or branched aliphatic group having 4 to 20 carbon atoms.)

Such an aliphatic group-containing polymerizable compound is not particularly limited as long as it has a linear or branched chain, which does not have a carbon ring and is saturated or unsaturated; however, examples thereof include isoamyl (meth)acrylate, stearyl (meth)acrylate, lauryl (meth)acrylate, octyl (meth)acrylate, decyl (meth)acrylate, isodecyl (meth)acrylate, isononyl (meth)acrylate, isomyristyl (meth)acrylate, isostearyl (meth)acrylate, 2-hydroxybutyl (meth)acrylate, butoxyethyl (meth)acrylate, 2-hydroxyethyl (meth)acrylate, 2-hydroxypropyl (meth)acrylate, and the like. Among these, an aliphatic group-containing polymerizable compound having a saturated linear chain or a branched chain is preferable, and lauryl (meth)acrylate (LA) and isononyl (meth)acrylate are more preferable. When such an aliphatic group-containing polymerizable compound is used, the adhesiveness of the ink coating film tends to be improved.

When the aliphatic group-containing polymerizable compound is contained, the content thereof is preferably 1% to 20% by mass and more preferably 5% to 15% by mass with respect to the total amount of the ink composition. When the content of the aliphatic group-containing polymerizable compound is in the above-described range, the adhesiveness of the ink coating film tends to be further improved.

### 1.1.1.7 Urethane Acrylate

The monofunctional polymerizable compound may include a urethane acrylate. The urethane acrylate is not particularly limited as long as it is a (meth)acrylic acid ester having a urethane bond, and examples thereof include (methylcarbamoyloxy)ethyl (meth)acrylate, (ethylcarbamoyloxy)ethyl (meth)acrylate, (propylcarbamoyloxy)ethyl (meth)acrylate, (butylcarbamoyloxy)ethyl (meth)acrylate, (methylcarbamoyloxy)ethoxyethyl (meth)acrylate, (ethylcarbamoyloxy)ethoxyethyl (meth)acrylate, (propylcarbamoyloxy)ethoxyethyl (meth)acrylate, and (butylcarbamoyloxy)ethoxyethyl (meth)acrylate. When urethane acrylate is used, the adhesiveness of the ink coating film tends to be improved.

When the urethane acrylate is contained, the content thereof is preferably 1% to 20% by mass and more preferably 5% to 15% by mass with respect to the total amount of the ink composition. When the content of the urethane acrylate is in the above-described range, the adhesiveness of the ink coating film tends to be further improved.

### 1.1.1.8 Other Monofunctional Polymerizable Compounds

In addition to those described above, the monofunctional polymerizable compound may include, for example, an unsaturated carboxylic acid such as (meth)acrylic acid, itaconic acid, crotonic acid, isocrotonic acid, or maleic acid; a salt of the unsaturated carboxylic acid; an ester, a urethane, an amide, and an anhydride of the unsaturated carboxylic acid; and acrylonitrile, styrene, various unsaturated polyester, unsaturated polyether, and unsaturated polyamide. Specifically, the monofunctional polymerizable compound may include ethyl carbitol acrylate (CBA) or the like.

When the other monofunctional polymerizable compounds are contained, the content thereof is preferably 1% to 20% by mass and more preferably 5% to 15% by mass with respect to the total amount of the ink composition.

### 1.1.2 Polyfunctional Polymerizable Compound

The polymerizable compound may include a polyfunctional polymerizable compound. Examples of the polyfunctional polymerizable compound include a difunctional polymerizable compound containing two polymerizable functional groups and a tri- or higher functional polymerizable compound containing three or more polymerizable functional groups.

The content of the polyfunctional polymerizable compound is preferably 18 by mass or more, more preferably 3% by mass or more, still more preferably 5% by mass or more, and particularly preferably 8% by mass or more, with respect to the total amount of the ink composition. When the content of the polyfunctional polymerizable compound is in the above-described range, the curability and abrasion resistance tend to be more excellent while maintaining the flexibility of the ink.

From the viewpoint that the flexibility in the cured ink tends to be more excellent, the upper limit of the content of the polyfunctional polymerizable compound is preferably 30% by mass or less, more preferably 25% by mass or less, and still more preferably 20% by mass or less, with respect to the total amount of the ink composition.

In addition, from the same viewpoint, the content of the polyfunctional polymerizable compound is preferably 1% by mass or more, more preferably 58 by mass or more, and still more preferably 10% by mass or more, with respect to the total amount of the polymerizable compound. The content of the polyfunctional polymerizable compound is preferably 30% by mass or less, more preferably 25% by mass or less, still more preferably 20% by mass or less, and particularly preferably 15% by mass or less, with respect to the total amount of the polymerizable compound. When the content of the polyfunctional polymerizable compound is too high, the flexibility of the coating film after printing is insufficient, and thus the coating film tends to crack during processing such as stretching or bending, and the adhesiveness tends to be adversely affected.

### 1.1.2.1 Difunctional Polymerizable Compound

The polyfunctional polymerizable compound preferably includes a difunctional polymerizable compound. When the polyfunctional polymerizable compound includes a difunctional polymerizable compound, the curability tends to be more excellent.

The difunctional polymerizable compound is not particularly limited; however, examples thereof include a vinyl ether group-containing (meth)acrylate and a difunctional (meth)acrylate.

From the viewpoint that the ink tends to have more excellent curability and more excellent abrasion resistance, the content of the difunctional polymerizable compound is preferably 18 by mass or more, more preferably 3% by mass or more, still more preferably 5% by mass or more, and particularly preferably 8% by mass or more, with respect to the total amount of the polymerizable compound in the ink.

From the viewpoint that the flexibility in the cured ink tends to be more excellent, the upper limit of the content of the difunctional polymerizable compound is preferably 30% by mass or less, more preferably 25% by mass or less, and still more preferably 20% by mass or less, with respect to the total amount of the polymerizable compound in the ink.

In addition, from the same viewpoint, it is also preferable that the content of the difunctional polymerizable compound with respect to the total amount of the polymerizable compounds is set to be the same as the content of the polyfunctional polymerizable compound with respect to the total amount of the polymerizable compound.

### 1.1.2.1.1 Vinyl Ether Group-Containing (Meth)Acrylate

The difunctional polymerizable compound preferably contains a polymerizable compound (vinyl ether group-containing (meth)acrylate) represented by Formula (1). When the difunctional polymerizable compound includes such a vinyl ether group-containing (meth)acrylate, the viscosity of the ink composition tends to decrease, and the ejection stability tends to be further improved. In addition, the curability of the ink composition is further improved, and the recording speed can also be further increased as the curability is improved. Further, the abrasion resistance tends to be further improved.

H₂C═CR¹—CO—OR²—O—CH═CH—R³ (1)

(In Formula (1), R¹ is a hydrogen atom or a methyl group, R² is a divalent organic residue having 2 to 20 carbon atoms, and R³ is a hydrogen atom or a monovalent organic residue having 1 to 11 carbon atoms.)

In Formula (1) described above, examples of the divalent organic residue having 2 to 20 carbon atoms which is represented by R² include a linear, branched, or cyclic alkylene group having 2 to 20 carbon atoms, which may be substituted, an alkylene group having 2 to 20 carbon atoms and having an oxygen atom due to an ether bond and/or an ester bond in the structure, which may be substituted, a divalent aromatic group having 6 to 11 carbon atoms, which may be substituted. Among these, an alkylene group having 2 to 6 carbon atoms, such as an ethylene group, an n-propylene group, an isopropylene group, or a butylene group, or an alkylene group having 2 to 9 carbon atoms such as an oxyethylene group, an oxy n-propylene group, an oxyisopropylene group, or an oxybutylene group, which has an oxygen atom due to an ether bond in the structure, is preferable. Further, from the viewpoint of further lowering the viscosity of the composition and further improving the curability of the composition, a compound containing a glycol ether chain, in which R² is an alkylene group having 2 to 9 carbon atoms, where R² has an oxygen atom due to an ether bond in the structure, such as an oxyethylene group, an oxy n-propylene group, an oxyisopropylene group, or an oxybutylene group, is more preferable.

In Formula (1) described above, as the monovalent organic residue having 1 to 11 carbon atoms which is represented by R³, a linear, branched, or cyclic alkyl group having 1 to 10 carbon atoms, which may be substituted, or an aromatic group having 6 to 11 carbon atoms, which may be substituted, is suitable. Among these, an alkyl group having 1 to 2 carbon atoms, which is a methyl group or an ethyl group, or an aromatic group having 6 to 8 carbon atoms, such as a phenyl group or a benzyl group, is suitably used.

When each of the above-described organic residues is a group which may be substituted, the substituent thereof is divided into a group that contains a carbon atom and a group that does not contain a carbon atom. First, when the substituent is a group containing a carbon atom, the carbon atom is counted to be included in the number of carbon atoms in the organic residue. Although the group containing a carbon atom is not limited to the following groups, examples thereof include a carboxyl group and an alkoxy group. Next, although the group that does not contain a carbon atom is not limited to the following groups, examples thereof include a hydroxyl group and a halogen group.

Specific examples of the compound of Formula (1) are not particularly limited. However, examples thereof include 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these specific examples, 2-(2-vinyloxyethoxy)ethyl acrylate is particularly preferable in that the curability and viscosity of the composition can be easily balanced. It is noted that, in the present embodiment, 2-(2-vinyloxyethoxy)ethyl acrylate may be referred to as VEEA.

The content of the polymerizable compound represented by Formula (1) is preferably 18 by mass or more, more preferably 5% by mass or more, and still more preferably 10% by mass or more, with respect to the total amount of the polymerizable compound. When the content of the polymerizable compound represented by Formula (1) is in the above-described range, not only the curability but also the viscosity and abrasion resistance tend to be more excellent.

In addition, the content of the polymerizable compound represented by Formula (1) is preferably 30% by mass or less, more preferably 25% by mass or less, still more preferably 20% by mass or less, and particularly preferably 15% by mass or less, with respect to the total amount of the polymerizable compound. When the content of the polymerizable compound represented by Formula (1) is in the above-described range, the flexibility in the cured ink tends to be more excellent.

### 1.1.2.1.2 Difunctional (Meth)acrylate

The difunctional (meth)acrylate is not particularly limited; however, examples thereof include dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol diacrylate (TPGDA), tripropylene glycol dimethacrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, an ethylene oxide (EO) adduct di(meth)acrylate of bisphenol A, a propylene oxide (PO) adduct di(meth)acrylate of bisphenol A, hydroxypivalic acid neopentyl glycol di(meth)acrylate, and polytetramethylene glycol di(meth)acrylate.

Among these difunctional (meth)acrylates, the difunctional polymerizable compound preferably includes any one or more selected from 1,6-hexanediol diacrylate (1,6 HDDA), dipropylene glycol diacrylate (DPGDA), and tripropylene glycol diacrylate (TPGDA). When the difunctional polymerizable compound includes these compounds, the adhesiveness of the ink coating film and the curability of the ink tend to be more excellent.

From the viewpoint that adhesiveness and ink curability is more excellent, the content of the difunctional (meth)acrylate is preferably 18 by mass or more, more preferably 5% by mass or more, and still more preferably 10% by mass or more, with respect to the total amount of the polymerizable compound.

In addition, the content of the difunctional (meth)acrylate is preferably 30% by mass or less, more preferably 25% by mass or less, still more preferably 20% by mass or less, and particularly preferably 158 by mass or less, with respect to the total amount of the polymerizable compound.

### 1.1.2.2 Tri- or Higher Functional Polymerizable Compound

The polyfunctional polymerizable compound may include a tri- or higher functional polymerizable compound. When the polyfunctional polymerizable compound includes a tri- or higher functional polymerizable compound, the curability of the ink tends to be more excellent.

Examples of the tri- or higher functional polymerizable compound include trimethylolpropane tri(meth)acrylate, an ethylene oxide-modified trimethylolpropane tri(meth)acrylate, pentaerythritol tri(meth)acrylate, pentaerythritol tetra(meth)acrylate, dipentaerythritol hexaacrylate, dipentaerythritol hexa(meth)acrylate, ditrimethylolpropane tetra(meth)acrylate, glycerin propoxy tri(meth)acrylate, a caprolactone-modified trimethylolpropane tri(meth)acrylate, pentaerythritol ethoxy tetra(meth)acrylate, and a caprolactam-modified dipentaerythritol hexa(meth)acrylate.

Among these, the tri- or higher functional polymerizable compound preferably includes any one or more selected from trimethylolpropane triacrylate (TMPTA), ethylene oxide-modified trimethylolpropane triacrylate (TMP(EO)₃TA), and dipentaerythritol hexaacrylate (DPHA). When the tri- or higher functional polymerizable compound includes these compounds, the curability of the ink tends to be more excellent.

From the viewpoint that ink curability is more excellent, the content of the tri- or higher functional polymerizable compound is preferably 1% by mass or more, more preferably 58 by mass or more, and still more preferably 10% by mass or more, with respect to the total amount of the polymerizable compound.

In addition, the content of the tri- or higher functional polymerizable compound is preferably 30% by mass or less, more preferably 25% by mass or less, still more preferably 20% by mass or less, and particularly preferably 15% by mass or less, with respect to the total amount of the polymerizable compound.

### 1.1.3 Oligomer

The polymerizable compound may contain an oligomer. The oligomer refers to a multimer in which the polymerizable compound serves as a constitutional component, where the oligomer is a polymerizable compound having a molecular weight of more than 1,000 among polymerizable compounds having one or a plurality of polymerizable functional groups. It is noted that a polymerizable compound having a molecular weight of 1,000 or less is defined as the monomer. When the polymerizable compound contains an oligomer, the viscosity may be further reduced, and the abrasion resistance and the like may be further improved.

Such an oligomer is not particularly limited; however, examples thereof include a urethane acrylate oligomer having a urethane as a repeating structure, a polyester acrylate oligomer having an ester as a repeating structure, an epoxy acrylate oligomer having an epoxy as a repeating structure, an amine-modified oligomer, and the like.

Among these, a urethane acrylate oligomer is preferable, an aliphatic urethane acrylate oligomer or an aromatic urethane acrylate oligomer is more preferable, and an aliphatic urethane acrylate oligomer is still more preferable. In addition, the urethane acrylate oligomer is preferably a urethane acrylate oligomer which is tetra- or lower functional, and more preferably a difunctional urethane acrylate oligomer. When such an oligomer is used, the viscosity tends to be further reduced, and the abrasion resistance and the like tend to be further improved.

The radiation curable ink composition for ink jet according to the present embodiment may contain an amine-modified oligomer; however, from the viewpoint of the storage stability of the ink and from the viewpoint that the coating film tends to be colored to pale yellow, and furthermore, the ink for ink jet is likely to have a high viscosity although the amine-modified oligomer improves adhesiveness and curability, it is preferable not to contain the amine-modified oligomer or to contain a small amount of the amine-modified oligomer. The content thereof when contained is preferably more than 0% by mass and 5% by mass or less, more preferably more than 0% by mass and less than 1% by mass, still more preferably more than 0% by mass and 0.9% by mass or less, and particularly preferably more than 0% by mass and 0.5% by mass or less, with respect to the total amount of the ink composition.

The amine-modified oligomer is an oligomer having one or more amino groups in the molecule. The amine-modified oligomer may contain one or more functional groups other than the amino group, and it preferably contains two or more functional groups other than the amino group.

Examples of the amine-modified oligomer include an amine-modified (meth)acrylate oligomer.

The content of the amine-modified oligomer is preferably less than 5% by mass, more preferably less than 3% by mass, still more preferably less than 2% by mass, particularly preferably less than 1% by mass, more particularly preferably 0.9% by mass or less, still more particularly preferably 0.5% by mass or less, and even still more preferably 0% by mass or less, with respect to the total amount of the ink composition. When the content of the amine-modified oligomer is less than 5% by mass, the curability can be improved without increasing the viscosity of the radiation curable ink composition for ink jet.

In addition, the content of the amine-modified oligomer when the amine-modified oligomer is contained is more than 0% by mass with respect to the total amount of the ink composition; however, it may be 0.5% by mass or more, may be 18 by mass or more, or may be 28 by mass or more.

Examples of the commercially available product of the amine-modified oligomer include CN371 NS, CN373, CN374, CN383, CN386, CN550, and CN551 (product names, all of which are manufactured by Sartomer Company Inc.), PHOTOMER (registered trademark) 4771, PHOTOMER 4250, and PHOTOMER 4068 (all of which are manufactured by IGM RESINS B.V.), EBECRYL (registered trademark) 80, EBECRYL 7100, and EBECRYL P115 (all of which are manufactured by DAICEL-ALLNEX LTD.), and LAROMER (registered trademark) PO 77F, LAROMER PO 8996, and LAROMER PO 94F (all of which are manufactured by BASF SE).

Examples of the commercially available product of the oligomer include CN9893 (difunctional aliphatic urethane oligomer, manufactured by Sartomer Company Inc.), CN371NS (difunctional amine-modified oligomer), and the like.

The content of the oligomer when the oligomer is used is preferably 0.5% to 10% by mass, more preferably 0.5% to 5% by mass, and still more preferably 1% to 3% by mass, with respect to the total amount of the ink composition. When the content is within the above-described range, the viscosity may be further reduced, and the abrasion resistance and the like may be further improved.

The content of the oligomer when the oligomer is used is preferably 0.5% to 10% by mass, more preferably 0.9% to 5% by mass, and still more preferably 1% to 2% by mass, with respect to the total amount of the monomer in the ink composition. When the content is within the above-described range, the viscosity may be further reduced, and the abrasion resistance and the like may be further improved.

### 1.2 Photopolymerization Initiator

The radiation curable ink composition for ink jet according to the present embodiment contains a photopolymerization initiator, the photopolymerization initiator includes (2,4,6-trimethylbenzoyl)bis(p-tolyl)phosphine oxide, and the content of the (2,4,6-trimethylbenzoyl)bis(p-tolyl)phosphine oxide is 3% by mass or more with respect to a total amount of the ink composition.

The photopolymerization initiator is a compound that generates an active species by irradiation with radiation.

In the radiation curable ink composition for ink jet according to the present embodiment, the content of the photopolymerization initiator is 3% by mass or more, preferably 5% by mass or more, more preferably 7% by mass or more, still more preferably 98 by mass or more, and particularly preferably 10% by mass or more, with respect to the total amount of the ink composition.

The upper limit of the content of the photopolymerization initiator is not particularly limited; however, it is preferably 20% by mass or less, more preferably 17% by mass or less, still more preferably 15% by mass or less, and particularly preferably 128 by mass or less, with respect to the total amount of the ink composition.

### 1.2.1 TMO

The photopolymerization initiator includes (2,4,6-trimethylbenzoyl)bis(p-tolyl)phosphine oxide (TMO). (2,4,6-trimethylbenzoyl)bis(p-tolyl)phosphine oxide is a compound represented by the following chemical formula (CAS 270586-78-2). When the photopolymerization initiator includes a predetermined amount or more of (2,4,6-trimethylbenzoyl)bis(p-tolyl)phosphine oxide, the storage stability of the ink composition in the high temperature and low temperature environments can be made excellent.

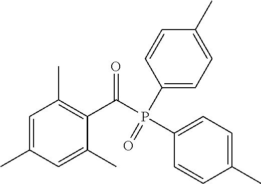

In the radiation curable ink composition for ink jet according to the present embodiment, the content of (2,4,6-trimethylbenzoyl)bis(p-tolyl)phosphine oxide is 3% by mass or more, preferably 58 by mass or more, more preferably 7% by mass or more, still more preferably 9% by mass or more, and particularly preferably 108 by mass or more, with respect to the total amount of the ink composition. When the content of (2,4,6-trimethylbenzoyl)bis(p-tolyl)phosphine oxide is in the above-described range, the storage stability of the ink composition in the high temperature and low temperature environments tends to be more excellent.

The upper limit of the content of (2,4,6-trimethylbenzoyl)bis(p-tolyl)phosphine oxide is not particularly limited; however, it is preferably 20% by mass or less, more preferably 17% by mass or less, still more preferably 15% by mass or less, and particularly preferably 12% by mass or less, with respect to the total amount of the ink composition.

The content of (2,4,6-trimethylbenzoyl)bis(p-tolyl)phosphine oxide is preferably 30% by mass or more, more preferably 50% by mass or more, and still more preferably 70% by mass or more, with respect to the total amount of the photopolymerization initiator.

### 1.2.2 Other Photopolymerization Initiators

The photopolymerization initiator may include other photopolymerization initiators other than (2,4,6-trimethylbenzoyl)bis(p-tolyl)phosphine oxide (TMO). Examples of other photopolymerization initiators include publicly known polymerization initiators such as an acylphosphine oxide-based polymerization initiator (excluding TMO), a thioxanthone-based polymerization initiator, an alkyl phenone-based polymerization initiator, and a benzophenone-based polymerization initiator. Among these, an acylphosphine oxide-based polymerization initiator and a thioxanthone-based polymerization initiator are preferable, and an acylphosphine oxide-based polymerization initiator is more preferable. It is noted that one kind of photopolymerization initiator may be used alone, or two or more kinds thereof may be used in combination.

The acylphosphine oxide-based polymerization initiator is not particularly limited; however, examples thereof include ethyl (2,4,6-trimethylbenzoyl)phenyl phosphinate (TPO-L), 2,4,6-trimethylbenzoyldiphenylphosphine oxide, bis(2,4,6-trimethylbenzoyl)-phenylphosphine oxide (819), bis-(2,6-dimethoxybenzoyl)-2,4,4-trimethylpentylphosphine oxide, and the like.

Examples of commercially available products of such acylphosphine oxide-based polymerization initiators include Omnirad TPO-L (ethyl (2,4,6-trimethylbenzoyl)phenyl phosphinate), Omnirad 819 (bis(2,4,6-trimethylbenzoyl)-phenylphosphine oxide), and Omnirad TPO (2,4,6-trimethylbenzoyldiphenylphosphine oxide) (product names, all of which are manufactured by IGM RESINS B.V.), IRGACURE 1800 (a mixture of bis-(2,6-dimethoxybenzoyl)-2,4,4-trimethylpentylphosphine oxide and 1-hydroxy-cyclohexyl phenyl ketone in a mass ratio of 25:75) (product names, all of which are manufactured by Ciba Specialty Chemicals), and the like.

The thioxanthone-based polymerization initiator is not particularly limited; however, examples thereof include thioxanthone, 2-methylthioxanthone, 2,4-diethylthioxanthone, 2-isopropylthioxanthone, 4-isopropylthioxanthone, 2-chlorothioxanthone, and 2,4-diethylthioxanthone, as well as 2,4-diethylthioxanthen-9-one (also known as 2,4-diethyl-9H-thioxanthen-9-one), a diester of carboxymethoxythioxanthone and polytetramethylene glycol, 1,3-di({α-[1-chloro-9-oxo-9H-thioxanthen-4-yl]oxy}acetylpoly[oxy (1-methylethylene)])oxy)-2,2-bis({α-[1-chloro-9-oxo-9H-thioxanthen-4-yl]oxy}acetylpoly[oxy (1-methylethylene)])oxymethylpropane.

It is noted that the thioxanthone-based polymerization initiator may be used as a sensitizing agent in combination with a photopolymerization initiator. The content of the sensitizing agent is preferably 0.18 by mass or more, more preferably 0.5% to 10% by mass, and still more preferably 1.0% to 5.0% by mass, with respect to the total amount of the ink composition. Examples of the commercially available product of the sensitizing agent include Speedcure DETX (manufactured by LAMBSON Ltd., 2,4-diethylthioxanthen-9-one).

The alkyl phenone-based polymerization initiator is not particularly limited; however, examples thereof include 2-hydroxy-1-(4-(4-(2-hydroxy-2-methylpropionyl)benzyl)phenyl)-2-methylpropan-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, and 2-methyl-1-(4-methylthiophenyl)-2-morpholinopropan-1-one.

The benzophenone-based polymerization initiator is not particularly limited; however, examples thereof include 4,4′-bis(diethylamino)benzophenone, 4-chlorobenzophenone, 4,4′-dimethoxybenzophenone, and 4,4′-diaminobenzophenone.

When the photopolymerization initiator includes other photopolymerization initiators, the content of the other photopolymerization initiators is preferably 10% by mass or less, more preferably 7% by mass or less, still more preferably 5% by mass or less, and particularly preferably 3% by mass or less, with respect to the total amount of the ink composition. The lower limit thereof is not particularly limited; however, it is preferably 0.1% by mass or more, more preferably 0.5% by mass or more, and still more preferably 1.08 by mass or more, with respect to the total amount of the ink composition.

Even when the photopolymerization initiator includes a photopolymerization initiator other than (2,4,6-trimethylbenzoyl)bis(p-tolyl)phosphine oxide (TMO), in case where the content thereof is in the above-described content, the storage stability of the ink composition in the high temperature and low temperature environments tends to be capable of being made excellent.

### 1.3 Polymerization Inhibitor

From the viewpoint of being able to further improve the storage stability of the ink composition, the radiation curable ink composition for ink jet according to the present embodiment may contain a polymerization inhibitor. One kind of polymerization inhibitor may be used alone, or two or more kinds thereof may be used in combination.

The polymerization inhibitor is not particularly limited; however, examples thereof include bis(2,2,6,6-tetramethyl-4-piperidyl-1-oxyl) sebacate (BiSTEMPO sebacate), 2,2,6,6-tetramethyl-4-hydroxypiperidin-1-oxyl (OH-TEMPO), p-methoxyphenol, hydroquinone monomethyl ether (MEHQ), 4-hydroxy-2,2,6,6-tetramethylpiperidine-N-oxyl, hydroquinone, cresol, t-butylcatechol, 3, 5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol), as well as a hindered amine compound, and the like.

In addition, examples of the commercially available product of the polymerization inhibitor include ADEKA STAB LA-7RD (2,2, 6, 6-tetramethyl-4-hydroxypiperidin-1-oxyl), LA-52, LA-57, LA-62, LA-63P, LA-68LD, LA-77Y, LA-77G, LA-81, LA-82 (1,2,2,6,6-pentamethyl-4-piperidyl methacrylate), and LA-87 (product names, all of which are manufactured by ADEKA Corporation), IRGASTAB UV 10 (4,4′-[1,10-dioxo-1,10-decanediyl]bis(oxy)bis[2,2,6,6-tetramethyl]-1-piperidinyl oxy) (CAS. 2516-92-9), TINUVIN 123 (4-hydroxy-2,2,6,6-tetramethylpiperidin-N-oxyl), TINUVIN 111FDL, TINUVIN 144, TINUVIN 152, TINUVIN 292, TINUVIN 765, TINUVIN 770DF, TINUVIN 5100, SANOL LS-2626, CHIMASSORB 119FL, CHIMASSORB 2020 FDL, CHIMASSORB 944 FDL, and TINUVIN 622 LD (product names, all of which are manufactured by BASF SE), and FA-711HM, FA-712HM (2,2,6,6-tetramethylpiperidinyl methacrylate, product name, manufactured by Hitachi Chemical Co., Ltd.), and UV-10 (product names, all of which are manufactured by Seiko Chemical Co., Ltd.).

The polymerization inhibitor preferably includes a 2,2,6,6-tetramethylpiperidine-N-oxyl (TEMPO)-based polymerization inhibitor. Since TEMPO has a stable free radical at room temperature, the radical supplementing ability is high, and the storage stability of the ink composition is excellent and tends to be capable of being improved.

Examples of the TEMPO-based polymerization inhibitor include 4-benzoyloxy TEMPO (4-benzoyloxy-2,2,6,6-tetramethylpiperidin-1-oxyl free radical), BiSTEMPO sebacate (bis(2,2,6,6-tetramethyl-4-piperidyl-1-oxyl) sebacate), 4-MCTEMPO (4-cyclohexylcarbonyloxy-2,2,6,6-tetramethylpiperidin-1-oxyl free radical), 4-AcTEMPO (4-acetyloxy-2,2,6,6-tetramethylpiperidin-1-oxyl free radical), EGG-TEMPO (a mixture of 4-[2-hydroxypropoxy-3-(2-hydroxyethoxy)]-TEMPO and 4-[3-hydroxypropoxy-2-(2-hydroxyethoxy)]-TEMPO), G-TEMPO (4-glycidyloxy-2,2,6,6-tetramethylpiperidin-1-oxyl free radical), OH-TEMPO (2,2,6,6-tetramethyl-4-hydroxypiperidin-1-oxyl), and the like.

In particular, the polymerization inhibitor more preferably includes any one or more selected from bis(2,2,6,6-tetramethyl-4-piperidyl-1-oxyl) sebacate and 2,2,6,6-tetramethyl-4-hydroxypiperidin-1-oxyl. When the polymerization inhibitor includes these compounds, the storage stability of the ink composition is more excellent and tends to be capable of being improved.

The content of the polymerization inhibitor is preferably 0.01% by mass or more and 1.0% by mass or less, more preferably 0.1% by mass or more and 0.5% by mass or less, and still more preferably 0.18 by mass or more and 0.2% by mass or less, with respect to the total amount of the ink composition.

In addition, the content of the TEMPO-based polymerization inhibitor is preferably 0.001% by mass or more and 1.0% by mass or less, more preferably 0.01% by mass or more and 0.5% by mass or less, and still more preferably 0.02% by mass or more and 0.1% by mass or less, with respect to the total amount of the ink composition.

### 1.4 Fluorescent Whitening Agent

The radiation curable ink composition for ink jet according to the present embodiment may contain a fluorescent whitening agent. When a fluorescent whitening agent is contained, yellowing of the cured product may be suppressed in some cases. In addition, by containing the fluorescent whitening agent, the curability can be made more excellent, and the whiteness of the cured product can be improved in some cases. It is noted that the yellowing of the cured product can be checked, for example, by a general-purpose colorimeter or the like.

The fluorescent whitening agent is not particularly limited; however, examples thereof include a naphthalene benzoxazole derivative such as 1,4-bis-(2-benzoxazolyl)naphthalene, a thiophene benzoxazoyl derivative such as 2,5-thiophenediyl bis(5-tert-butyl-1,3-benzoxazole), a stilbene benzoxazole derivative, a coumarin derivative, a styrenebiphenyl derivative, a pyrazolone derivative, a stilbene derivative, a styryl derivatives of benzene and biphenyl, a bis(benzazol-2-yl) derivative, carbostyril, naphthalimide, a dibenzothiophene-5, 5′-dioxide derivative, a pyrene derivative, and pyridotriazole.

Examples of the commercially available product of the fluorescent whitening agent include Telalux OB, Telalux KCB, Telalux KS, Telalux KS-N (all of which are manufactured by Clariant Japan), Tinopal OB-CO, and Tinopal NEW LIQ (all of which are manufactured by BASF SE).

In addition, it is preferable to use the fluorescent whitening agent in combination with an acylphosphine oxide-based polymerization initiator (including TMO). As a result, the curability tends to be capable of being further excellent.

The content of the fluorescent whitening agent when the fluorescent whitening agent is used is preferably 0.01% by mass or more and 1.0% by mass or less, and more preferably 0.10% by mass or more and 0.50% by mass or less, with respect to the total amount of the ink composition.

### 1.5 Coloring Material

The radiation curable ink composition for ink jet according to the present embodiment may further contain a coloring material. As the coloring material, at least one of a pigment and a dye can be used.

The total content of the coloring material is preferably 0.1% by mass or more and 10.0% by mass or less, more preferably 0.5% by mass or more and 5.0% by mass or less, with respect to the total amount of the ink composition. It is noted that the radiation curable ink composition for ink jet according to the present embodiment may be used as a clear ink that does not contain a coloring material or contains a coloring material to an extent that is not intended for coloring (for example, 0.18 by mass or less).

It is noted that when a pigment is used, a pigment dispersion liquid may be prepared in advance and used for the radiation curable ink composition for ink jet. The pigment dispersion liquid may contain a polymerizable compound, a dispersing agent for dispersing a pigment (described later), and the like.

### 1.5.1 Pigment

When a pigment is used as the coloring material, the weather resistance of the ink composition may be improved. Examples of the pigment include an inorganic pigment and an organic pigment.

As the inorganic pigment, carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite), iron oxide, titanium oxide, zinc oxide, and silica can be used.

Examples of the carbon black include No. 2300, 900, MCF88, No. 20B, No. 33, No. 40, No. 45, No. 52, MA7, MA8, MA100, and No. 2200B manufactured by Mitsubishi Chemical Corporation. Examples of the carbon black also include color black FW1, FW2, FW2V, FW18, FW200, S150, S160, and S170, Pretex 35, U, V, and 140U, and special black 6, 5, 4A, 4, and 250 manufactured by Degussa AG. Examples of the carbon black also include Conductex SC and Raven 1255, 5750, 5250, 5000, 3500, 1255, and 700 manufactured by Columbia Carbon Company. Examples of the carbon black also include Regal 400R, 330R, and 660R, Mogul L, Monarch 700, 800, 880, 900, 1000, 1100, 1300, and 1400, and Elftex 12 manufactured by Cabot Corporation.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment.

Specific examples of organic pigments include the following.

Examples of the cyan pigment include C.I. Pigment Blue 1, 2, 3, 15:3, 15:4, 15:34, 16, 22, 60, and the like; C.I. Vat Blue 4, 60; and the like, and are preferably one or a mixture of two or more selected from the group consisting of C.I. Pigment Blue 15:3, 15:4, and 60.

Examples of a magenta pigment include C.I. Pigment Red 5, 7, 12, 48, 48, 57, 57:1, 112, 122, 123, 168, 184, and 202 and C.I. Pigment Violet 19, and one or a mixture of two or more selected from the group consisting of C.I. Pigment Red 122, 202, and 209 and C.I. Pigment Violet 19 is preferably used. A solid solution of the pigment is also favorable.

Examples of the yellow pigment include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferably include one or a mixture of two or more selected from the group consisting of C.I. Pigment Yellow 74, 109, 110, 128, 138, 155, and 180.

Examples of the orange pigment include C.I. Pigment Orange 36 or 43. or a mixture thereof. Examples of the green pigment include C.I. Pigment Green 7 or 36 or a mixture thereof.

In addition, a bright pigment may be used, the pigment is not particularly limited as long as the pigment is able to exhibit brightness when adhered to a medium; however, examples thereof include metal particles of one or two or more alloys (also referred to as metal pigment) selected from the group consisting of aluminum, silver, gold, platinum, nickel, chromium, tin, zinc, indium, titanium, and copper, a pearl pigment having pearl gloss, and the like. Representative examples of the pearl pigment include a pigment having pearl gloss or interference gloss, such as titanium dioxide-coated mica, fish scale foil, and bismuth oxychloride. In addition, the bright pigment may be subjected to a surface treatment for suppressing a reaction with water.

In addition, a white pigment may be used, and examples of the white pigment include metal compounds such as metal oxide, barium sulfate, and calcium carbonate. Examples of the metal oxide include titanium dioxide, zinc oxide, silica, alumina, and magnesium oxide. In addition, particles having a hollow structure may be used for the white pigment.

One kind of the pigment may be used alone, or two or more kinds thereof may be used in combination. The pigment is preferably an organic pigment from the viewpoint of storage stability such as light resistance, weather resistance, and gas resistance.

From the viewpoint that the present disclosure is more effective, the radiation curable ink composition for ink jet according to the present embodiment is preferably a black ink or a yellow ink. When the ink composition is a black ink, it is preferable that the ink composition contains carbon black as a coloring material. When the ink composition is a yellow ink, it is preferable that the ink composition contains a yellow pigment as a coloring material. The coloring material to be used for the black ink or the yellow ink, particularly the carbon black or the yellow pigment, is easily affected by the functional group on the surface of the coloring material, and it is more difficult to maintain the dispersion stability than other coloring materials. Since a liquid type photopolymerization initiator such as TPO-L contains a large amount of impurities, the impurities and the functional groups on the surface of the coloring material react with each other, and the storage stability of the ink composition in a high temperature environment is likely to be inferior. On the other hand, since the radiation curable ink composition for ink jet according to the present embodiment contains TMO, the storage stability of the ink composition in a high temperature environment can be made excellent even in a case of a black ink or a yellow ink.

For the volume average particle diameter (D50) of the pigment, a volume average particle diameter (D50) when measured by a dynamic light scattering method is 20 nm or more and 300 nm or less, the volume average particle diameter (D50) is more preferably 30 nm or more and 200 nm or less, and the volume average particle diameter (D50) is still more preferably 40 nm or more and 100 nm or less.

The measurement of the volume average particle diameter may be carried out by using, for example, a Nanotrac series particle diameter distribution measurement device manufactured by MicrotracBEL Corp. In addition, examples of a method of adjusting the volume average particle diameter include a method of adjusting a volume average particle diameter by adjusting a degree of pulverization of a pigment before dispersion, a method of adjusting a volume average particle diameter by adjusting stirring conditions (for example, stirring speed, stirring temperature, and the like) during dispersion, a method of adjusting a volume average particle diameter by filtration using a filter after dispersion, and the like.

When the radiation curable ink composition for ink jet contains a pigment, a dispersing agent may be further contained in order to further improve the pigment dispersibility. One kind of dispersing agent may be used alone, or two or more kinds thereof may be used in combination.

The dispersing agent is not particularly limited; however, examples thereof include a dispersing agent that is commonly used to prepare a pigment dispersion liquid, such as a polymeric dispersing agent. Specific examples thereof include those containing, as a main component, one or more of a polyoxyalkylene, a polyalkylene polyamine, a vinyl-based polymer and a vinyl-based copolymer, an acrylic polymer and an acrylic copolymer, a polyester, a polyamide, a polyimide, a polyurethane, an amino-based polymer, a silicon-containing polymer, a sulfur-containing polymer, a fluorine-containing polymer, and an epoxy resin.

Examples of the commercially available product of the polymeric dispersing agent include the AJISPER series manufactured by Ajinomoto Fine-Techno Co., Inc., the Solsperse series (Solsperse 22000, 32000, 36000, or the like) available from Lubrizol Japan Ltd., the DISPERBYK series manufactured by BYK Additives & Instruments, and the DISPARLON series manufactured by Kusumoto Chemicals, Ltd.

The content of the dispersing agent when the dispersing agent is used is preferably 0.01% by mass or more and 5.0% by mass or less, more preferably 0.18 by mass or more and 4.0% by mass or less, still more preferably 0.5% by mass or more and 3.0% by mass or less, and particularly preferably 1.0% by mass or more and 2.0% by mass or less, with respect to the total amount of the ink composition.

### 1.5.2 Dye

A dye may be used as the coloring material. Although not particularly limited, acid dye, direct dye, reactive dye, and basic dye can be used as the dye. One kind of the dye may be used alone, or two or more kinds thereof may be used in combination.

The dye is not particularly limited; however, examples thereof include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C. I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

### 1.6 Surfactant

The radiation curable ink composition for ink jet according to the present embodiment may contain a surfactant. The surfactant is not particularly limited; however, examples thereof include an acetylene glycol-based surfactant, a fluorine-based surfactant, and a silicone-based surfactant.

The acetylene glycol-based surfactant is not particularly limited; however, examples thereof include 2,4,7,9-tetramethyl-5-decyne-4,7-diol and an alkylene oxide adduct of 2,4,7,9-tetramethyl-5-decyne-4,7-diol, as well as 2,4-dimethyl-5-decyne-4-ol and an alkylene oxide adduct of 2,4-dimethyl-5-decyne-4-ol, and the like.

Examples of the fluorine-based surfactant include, but are not particularly limited to, a perfluoroalkyl sulfonate, a perfluoroalkyl carboxylate, a perfluoroalkyl phosphate, a perfluoroalkyl ethylene oxide adduct, a perfluoroalkyl betaine, and a perfluoroalkylamine oxide compound.

Examples of the silicone-based surfactant include a polysiloxane-based compound, a polyester-modified silicone, a polyether-modified organosiloxane, and the like. Examples of the polyester-modified silicone include BYK-347, 348, 3510, and 3530 (all of which are manufactured by BYK Additives & Instruments), and examples of the polyether-modified silicone include BYK-3570 and BYK-UV3500 (manufactured by BYK Additives & Instruments), and the like.

The content of the surfactant is preferably 0.1% to 1% by mass and more preferably 0.2% to 0.8% by mass with respect to the total mass of the ink composition. When the content of the surfactant is within the above-described range, the wettability of the ink composition tends to be further improved.

### 1.7 Other Components

The radiation curable ink composition for ink jet according to the present embodiment may further contain, as necessary, various additives such as a chain transfer agent, a crosslinking agent, an antioxidant, a preservative, a flame retardant, an antistatic agent, and an organic or inorganic filler.

The content of such an additive is not particularly limited; however, it is preferably 0.01% by mass to 20% by mass, more preferably 0.1% by mass to 15% by mass, still more preferably 18 by mass to 10% by mass, and particularly preferably 2% by mass to 5% by mass, with respect to the total mass of the ink composition.

### 1.8 Physical Properties

The viscosity of the radiation curable ink composition for ink jet according to the present embodiment at 20° C. is preferably less than 30 mPa·s, more preferably less than 20 mPa·s, and still more preferably less than 10 mPa·s. When the viscosity of the ink composition at 20° C. is within the above-described range, the ink composition can be appropriately ejected from the nozzle, and the flight deflection and scattering of the ink composition can be further reduced, and thus the ink composition can be suitably used in an ink jet recording device.

It is noted that, for the viscosity measurement, it is possible to carry out measurement by raising the Shear Rate from 10 to 1000 in an environment of 20° C. and reading a viscosity at a Shear Rate at 200 hours by using a viscoelasticity tester MCR-300 (manufactured by Pysica).

The surface tension of the radiation curable ink composition for ink jet according to the present embodiment at 20° C. is preferably 20 mN/m or more and 40 mN/m or less. When the surface tension of the radiation curable ink composition for ink jet at 20° C. is in this range, the ink composition is less likely to wet the nozzle surface that is subjected to a liquid repellent treatment. As a result, the ink composition can be normally and appropriately ejected from the nozzle, and the flight deflection and scattering of the ink composition can be further reduced, and thus the ink composition can be suitably used in an ink jet recording device.

It is noted that the surface tension can be measured by checking the surface tension when a platinum plate is wetted with the radiation curable ink composition for ink jet in an environment of 20° C. using, for example, an automatic surface tensiometer CBVP-Z (manufactured by Kyowa Interface Science Co., Ltd.).

### 1.9 Production Method

The production (preparation) of the radiation curable ink composition for ink jet can be carried out, for example, by mixing each component contained in the ink composition and carrying out stirring so that the components are mixed sufficiently and uniformly. In the present embodiment, the preparation of the radiation curable ink composition for ink jet preferably includes subjecting a mixture obtained by carrying out mixing with at least a part of the polymerizable compound to at least any of an ultrasonic treatment and a heating treatment in the preparation process. As a result, the amount of dissolved oxygen in the ink composition after preparation can be reduced, and the radiation curable ink composition for ink jet can be made to have excellent ejection stability and excellent storage stability in some cases. The above-described mixture may be any mixture as long as it contains at least the above components, may be a mixture that further contains other components contained in the radiation curable ink composition for ink jet, or may be a mixture that contains all the components contained in the radiation curable ink composition for ink jet. It suffices that the polymerizable compound contained in the mixture is at least a part of the polymerizable compound contained in the radiation curable ink composition for ink jet.

### 2. RECORDING DEVICE

A recording device in which the above-described radiation curable ink composition for ink jet can be preferably used will be described.

The recording device according to the present embodiment preferably includes an ink jet head that ejects the above-described radiation curable ink composition for ink jet, and the above-described radiation curable ink composition for ink jet. In addition, the recording device according to the present embodiment may include a radiation source that emits radiation to the ink composition.

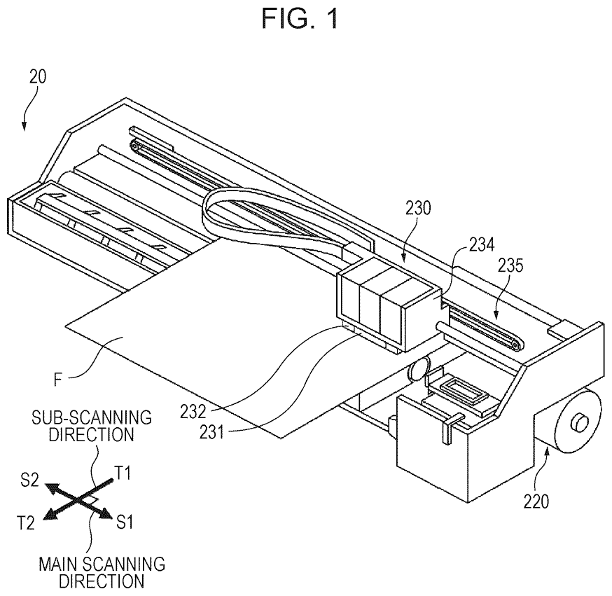

As an example of the recording device, FIG. 1 shows a perspective view of a serial printer. As shown in FIG. 1, a serial printer 20 includes a transport portion 220 and a recording portion 230. The transport portion 220 transports the recording medium F fed to the serial printer to the recording portion 230, and the recording medium after recording is discharged outside the serial printer. Specifically, the transport portion 220 includes each feeding roller and transports the fed recording medium F in a sub-scanning direction T2.

In addition, the recording portion 230 includes an ink jet head 231 that ejects the above-described radiation curable ink composition for ink jet to the recording medium F fed from the transport portion 220, a radiation source 232 that irradiates the attached ink composition with radiation, a carriage 234 on which these are mounted, and a carriage movement mechanism 235 that moves the carriage 234 in the main scanning directions S1 and S2 of the recording medium F.

In the case of the serial printer, a head having a length smaller than the width of the recording medium is provided as the ink jet head 231, the head moves, and recording is carried out by one or two or more passes. In addition, in the serial printer, the head 231 and the radiation source 232 are mounted in the carriage 234 that moves in a predetermined direction, and the head moves in association with the movement of the carriage to eject the ink composition onto the recording medium. As a result, recording is carried out by one or two or more passes. It is noted that the pass is also referred to as the main scanning. Sub-scanning for transporting the recording medium may be carried out between the passes. That is, the main scanning and the sub-scanning are alternately carried out.

It is noted that although an aspect in which the radiation source is mounted on the carriage is illustrated in FIG. 1, the present disclosure is not limited thereto, and the radiation source may not be mounted on the carriage.

In addition, the recording device according to the present embodiment is not limited to the serial type printer, and it may be the line type printer described above.

### 3. EXAMPLES

Hereinafter, the present disclosure will be described in more detail with reference to examples, but the present disclosure is not limited to these examples. Hereinafter, “%” is based on mass unless otherwise specified.

### 3.1 Preparation of Radiation Curable Ink Composition for Ink Jet

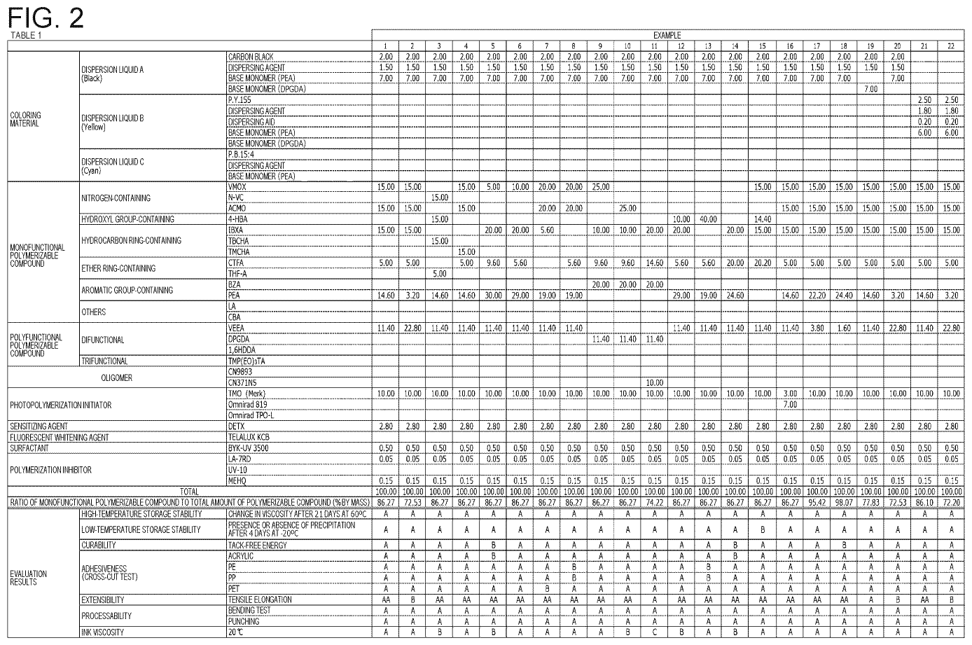

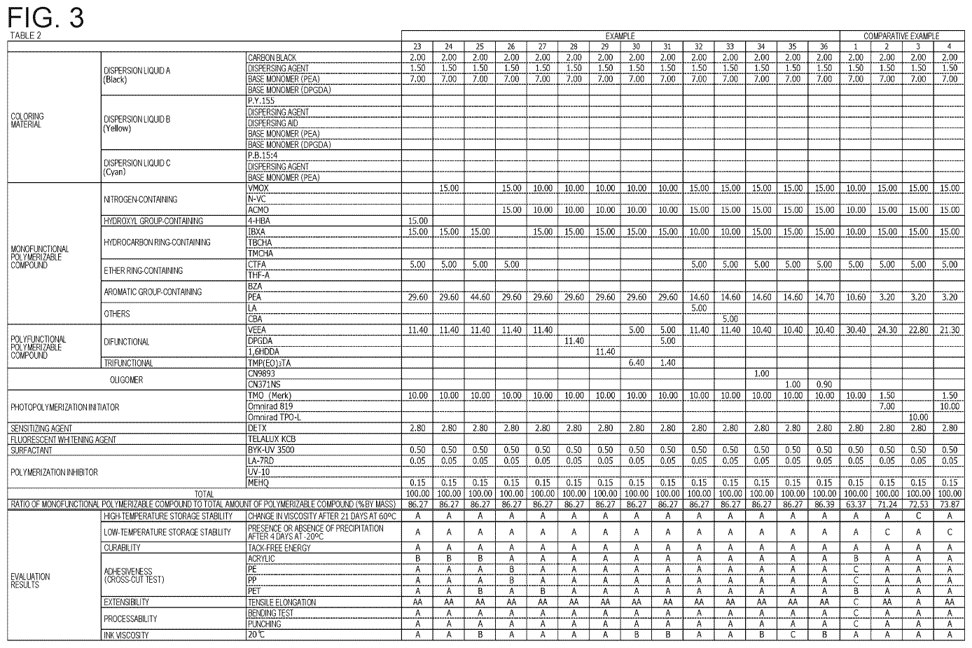

First, a pigment, a dispersing agent, a part of a polymerizable compound (base monomer), and, as necessary, a dispersing aid are weighed and put into a tank for pigment dispersion, and a ceramic bead mill having a diameter of 1 mm is put into a tank and stirred to obtain a pigment dispersion liquid in which the pigment is dispersed in the base monomer. Next, the remaining polymerizable compound, a photopolymerization initiator, a sensitizing agent, a fluorescent whitening agent, a surfactant, and a polymerization inhibitor are put into a mixture tank, which is a stainless container, so that the composition shown in Table 1 (shown in FIG. 2) or Table 2 (shown in FIG. 3) is obtained, then the resultant mixture is completely dissolved by mixing and stirring, the pigment dispersion liquid obtained above is charged thereto, mixing and stirring is further carried out at normal temperature for 1 hour, and filtering with a 5 μm membrane filter is further carried out to obtain a radiation curable ink composition for ink jet according to each of the examples. It is noted that the numerical values of the respective components shown in the examples in the table are indicated in terms of % by mass.

Descriptions regarding Table 1 and Table 2 will be supplemented.

### Dispersion Liquid

Carbon black: (product name “MA-100”, manufactured by Mitsubishi Chemical Corporation)
P. Y. 155: C. I. Pigment Yellow 155
P. B. 15:4: C. I. Pigment Blue 15:4
Dispersing agent: Product name “Solsperse 32000”, manufactured by Lubrizol Japan Ltd., polymeric dispersing agent, amine value: 35
Dispersing aid: Product name “Solsperse 22000”, manufactured by Lubrizol Japan Ltd.

### Monofunctional Polymerizable Compound

VMOX: 5-methyl-3-vinyl-oxazolidin-2-one, manufactured by BASF Japan Ltd.
N-VC: n-vinylcaprolactam, manufactured by BASF Japan Ltd.
ACMO: Acryloylmorpholine, manufactured by KJ Chemicals Corporation
4-HBA: 4-hydroxybutyl acrylate, manufactured by Osaka Organic Chemical Industry Ltd.
IBXA: Isobornyl acrylate, manufactured by Osaka Organic Chemical Industry Ltd.
TBCHA: t-butylcyclohexyl acrylate, product name “EM105”, manufactured by ETERNAL MATERIALS Co., Ltd.
TMCHA: 3,3,5-trimethylcyclohexylacrylate, product name “EM2104”, manufactured by ETERNAL MATERIALS Co., Ltd.
CTFA: Cyclic trimethylolpropane formal acrylate, product name “VISCOAT #200”, manufactured by Osaka Organic Chemical Industry Ltd.
THF-A: Tetrahydrofurfuryl acrylate, product name “VISCOAT #150”, manufactured by Osaka Organic Chemical Industry Ltd.
BZA: Benzyl acrylate, product name “VISCOAT #160”, manufactured by Osaka Organic Chemical Industry Ltd.
PEA: Phenoxyethyl acrylate, product name “VISCOAT #192”, manufactured by Osaka Organic Chemical Industry Ltd.
LA: Lauryl acrylate, manufactured by Osaka Organic Chemical Industry Ltd.
CBA: Ethyl carbitol acrylate, product name “VISCOAT #190”, manufactured by Osaka Organic Chemical Industry Ltd.

### Polyfunctional Polymerizable Compound

VEEA: 2-(2-vinyloxyethoxy)ethyl acrylate, manufactured by Nippon Shokubai Co., Ltd.
DPGDA: Dipropylene glycol diacrylate, product name “SR508NS”, manufactured by Sartomer Company Inc.
1,6 HDDA: 1,6-hexanediol diacrylate, product name “SR238NS”, manufactured by Sartomer Company Inc.
TMP (EO)₃ TA: EO-modified trimethylolpropane triacrylate, product name “EM2380”, manufactured by ETERNAL MATERIALS Co., Ltd.

### Oligomer

CN9893: Difunctional aliphatic urethane oligomer, product name “CN9893 NS”, manufactured by Sartomer Company Inc.
CN371NS: Amine-modified oligomer, manufactured by Sartomer Company Inc.

### Photopolymerization Initiator

TMO: (2,4,6-trimethylbenzoyl)bis(p-tolyl)phosphine oxide, manufactured by Merck KGaA.
Omnirad 819: Product name, manufactured by IGM, bis(2,4,6-trimethylbenzoyl)phenylphosphine oxide
Omnirad TPO-L: Product name, manufactured by IGM, ethylphenyl (2,4,6-trimethylbenzoyl) phosphinate

### Sensitizing Agent

DETX: Product name “Speedcure DETX”, manufactured by LAMBSON Ltd., 2,4-diethylthioxanthen-9-one

### Fluorescent Whitening Agent

Telalux KCB: 1, 4-bis-(2-benzoxazole)naphthalene, manufactured by Clariant Japan.

### Surfactant

BYK-UV3500: Product name, manufactured by BYK Additives & Instruments.

### Polymerization Inhibitor

LA-7RD: Product name “ADEKA STAB LA-7RD” (2,2,6,6-tetramethyl-4-hydroxypiperidin-1-oxyl), manufactured by ADEKA Corporation
UV-10: BiSTEMPO sebacate (bis(2,2, 6, 6-tetramethyl-4-piperidyl-1-oxyl) sebacate), manufactured by Seiko Chemical Co., Ltd.
MEHQ: p-methoxyphenol, manufactured by Kanto Chemical Co., Inc.)

### 3.2 Evaluation Method

### 3.2.1 High-temperature Storage Stability

A glass bottle is filled with the radiation curable ink composition for ink jet according to each of the above-obtained examples and stored at 60° C. for 21 days. The viscosity at 20° C. before and after storage is measured in the same manner as described above to check the change in viscosity before and after storage. The evaluation standards are shown below.

### Evaluation Standards

A: Thickening rate is less than 5%.
B: Thickening rate is 5% or more and less than 10%.
C: Thickening rate is 10% or more.

### 3.2.2 Low-Temperature Storage Stability

A glass bottle is filled with the radiation curable ink composition for ink jet according to each of the above-obtained examples and stored at −20° C. for 4 days. The ink composition before and after storage is filtered and collected with a metal mesh filter, and the filter is visually checked. The evaluation standards are shown below.

### Evaluation Standards

A: Generation of foreign matter is not observed.
B: Generation of foreign matter is observed.

### 3.2.3 Curability

The cotton swab weighting tackiness evaluation is carried out. Specifically, the radiation curable ink composition for ink jet according to each of the above-obtained examples is applied onto a polyvinyl chloride medium with a bar coater so that the coating thickness of the ink composition is 10 μm, and ultraviolet irradiation is carried out at a speed of 0.04 sec/cm at a predetermined irradiation intensity. In this case, as the light source, an LED having a peak wavelength of 395 nm is used. Then, the surface of the coating film is rubbed with a cotton swab, and the curability is evaluated with reference to the irradiation energy at which the cotton swab is not colored. The evaluation standards are as follows.

### Evaluation Standards

A: Irradiation energy is less than 200 mJ/cm².
B: Irradiation energy is 200 mJ/cm² or more and less than 350 mJ/cm².
C: Irradiation energy is 350 mJ/cm² or more and less than 500 mJ/cm².

### 3.2.4 Adhesiveness

The radiation curable ink composition for ink jet according to each of the above-obtained examples is applied onto an acrylic, PE, PP, or PET base material with a bar coater so that the coating thickness is 10 μm, and ultraviolet irradiation is carried out so that the accumulated energy reaches an irradiation intensity of 200 mJ/cm². In this case, as the light source, an LED having a peak wavelength of 395 nm is used. Then, the obtained coating film is evaluated by a cross-cut test in accordance with JIS K5600-5-6.

More specifically, a blade of a cutting tool is applied to the coating film to be perpendicular to the coating film, and a cutter is used to make a grid in which the distance between cuts is 1 mm, thereby making a grid of 10×10 squares. A transparent adhesive tape (width: 25 mm) having a length of about 75 mm is attached to the grid, and the tape is rubbed with a finger so that the cured film can be seen through the tape. Next, within 5 minutes after the attachment of the tape, the tape is reliably peeled off from the cured film at an angle close to 60° and in 0.5 to 1.0 seconds, and the state of the grid is observed visually. The evaluation standards are as follows.

### Evaluation Standards

A: The peeling-off of the cured film is observed in less than 10% of the grid.
B: The peeling-off of the cured film is observed in 10% or more and less than 35% of the grid.
C: The peeling-off of the cured film is observed in 35% or more of the grid.

### 3.2.5 Extensibility

The radiation curable ink composition for ink jet according to each of the above-obtained examples is applied, with a bar coater, onto a polyvinyl chloride film (JT5829R, manufactured by MACtac) to have a thickness of 10 μm. Next, a metal halide lamp (manufactured by EYE GRAPHICS Co., Ltd.) is used to carry out curing with an energy of 400 mJ/cm², thereby forming a coating film. The peeling paper of the vinyl chloride film on which the coating film is formed is peeled off, and then is cut out into a strip shape having a width of 1 cm and a length of 8 cm to prepare a test piece. For each test piece, the elongation rate as extensibility is measured using a tensile tester (TENSILON, manufactured by ORIENTEC CO., LTD.). The elongation rate is defined as a numerical value at the time of occurrence of cracking when pulled at 5 mm/min. The numerical value is calculated from {(length at the time of cracking−length before extension)/length before extension×100}. The evaluation standards are shown below.

### Evaluation Standards

AA: Peeling-off is not observed.
A: The peeling-off of the cured film is observed in less than 10% of the grid.
B: The peeling-off of the cured film is observed in 10% or more and less than 35% of the grid.
C: The peeling-off of the cured film is observed in 35% or more of the grid.

### 3.2.6 Processability (Bending Test)

The radiation curable ink composition for ink jet according to each of the above-obtained examples is applied, with a bar coater, onto a polyvinyl chloride medium with a bar coater to have a thickness of 10 μm, and ultraviolet irradiation is carried out so that the accumulated energy reaches 200 mJ/cm². In this case, as the light source, an LED having a peak wavelength of 395 nm is used. Then, the obtained coating film is bent at 180° to evaluate the presence or absence of cracking occurrence. The evaluation standards are shown below.

### Evaluation Standards

A: No crack
B: With crack

### 3.2.7 Processability (Punching)

The radiation curable ink composition for ink jet according to each of the above-obtained examples is applied, with a bar coater, onto a polyvinyl chloride medium with a bar coater to have a thickness of 10 μm, and ultraviolet irradiation is carried out so that the accumulated energy reaches 200 mJ/cm². In this case, as the light source, an LED having a peak wavelength of 395 nm is used. Then, a punch (diameter: 8 mm) is placed against the obtained coating film, the punch is struck with a hammer, and the coating film is punched out. It is evaluated whether or not cracking occurs in the punched coating film. The evaluation standards are shown below.

### Evaluation Standards

A: No crack
B: With crack

### 3.2.8 Ink Viscosity

Using a rotational viscometer (product name “Rheometer MCR-301”, manufactured by Anton Paar GmbH), the viscosity of the radiation curable ink composition for ink jet according to each of the above-obtained examples is measured in a 20° C. environment. The evaluation standards are as follows.

### Evaluation Standards

A: Viscosity is less than 13 mPa·s.
B: Viscosity is 13 mPa's or more and less than 23 mPa·s.
C: Viscosity is 23 mPa·s or more.

### 3.3 Evaluation Results

The evaluation results are shown in Table 1 and Table 2.

From the evaluation results in Table 1 and Table 2, it is possible to achieve both excellent adhesiveness and excellent storage stability of the ink composition in the high temperature and low temperature environments, by using the radiation curable ink composition for ink jet according to each of the examples, which contains a polymerizable compound and a photopolymerization initiator, where the photopolymerization initiator includes (2,4,6-trimethylbenzoyl)bis(p-tolyl)phosphine oxide, a content of the (2,4,6-trimethylbenzoyl)bis(p-tolyl)phosphine oxide is 3% by mass or more with respect to a total amount of the ink composition, the polymerizable compound includes a monofunctional polymerizable compound, and a content of the monofunctional polymerizable compound is 70% by mass or more with respect to a total amount of the polymerizable compound.

On the other hand, the radiation curable ink composition for ink jet according to each of the comparative examples that do not satisfy the above-described configuration is inferior in terms of at least any of adhesiveness, the storage stability of the ink composition in a high temperature environment, and the storage stability of the ink composition in a low temperature environment.

The following contents are derived from the above-described embodiments.

According to one aspect of a radiation curable ink composition for ink jet, the radiation curable ink composition for ink jet contains a polymerizable compound and a photopolymerization initiator, where the photopolymerization initiator includes (2,4,6-trimethylbenzoyl)bis(p-tolyl)phosphine oxide, a content of the (2,4,6-trimethylbenzoyl)bis(p-tolyl)phosphine oxide is 3% by mass or more with respect to a total amount of the ink composition, the polymerizable compound includes a monofunctional polymerizable compound, and a content of the monofunctional polymerizable compound is 70% by mass or more with respect to a total amount of the polymerizable compound.

In one aspect of the radiation curable ink composition for ink jet, the content of the monofunctional polymerizable compound may be 85% by mass or more with respect to the total amount of the polymerizable compound.

In any aspect of the radiation curable ink composition for ink jet, the monofunctional polymerizable compound may include a nitrogen-containing monofunctional polymerizable compound.

In any aspect of the radiation curable ink composition for ink jet, the monofunctional polymerizable compound may include a hydroxyl group-containing monofunctional polymerizable compound.

In any aspect of the radiation curable ink composition for ink jet, the monofunctional polymerizable compound may include a saturated hydrocarbon ring-containing monofunctional polymerizable compound.

In any aspect of the radiation curable ink composition for ink jet, the monofunctional polymerizable compound may include an ether ring-containing monofunctional polymerizable compound.

In any aspect of the radiation curable ink composition for ink jet, the monofunctional polymerizable compound may include an aromatic group-containing monofunctional polymerizable compound.

In any aspect of the radiation curable ink composition for ink jet, the radiation curable ink composition for ink jet may further contain a polymerization inhibitor, where the polymerization inhibitor includes any one or more selected from bis(2,2,6,6-tetramethyl-4-piperidyl-1-oxyl) sebacate and 2,2,6,6-tetramethyl-4-hydroxypiperidin-1-oxyl.

In any aspect of the radiation curable ink composition for ink jet, the radiation curable ink composition for ink jet may contain a fluorescent whitening agent.

In any aspect of the radiation curable ink composition for ink jet, the polymerizable compound may include a polyfunctional polymerizable compound, and the polyfunctional polymerizable compound may include a difunctional polymerizable compound.

In any aspect of the radiation curable ink composition for ink jet, the difunctional polymerizable compound may include a polymerizable compound represented by Formula (1).

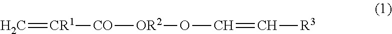

(In Formula (1), R¹ is a hydrogen atom or a methyl group, R² is a divalent organic residue having 2 to 20 carbon atoms, and R³ is a hydrogen atom or a monovalent organic residue having 1 to 11 carbon atoms.)

In any aspect of the radiation curable ink composition for ink jet, the difunctional polymerizable compound may include any one or more selected from 1,6-hexanediol diacrylate, dipropylene glycol diacrylate, and tripropylene glycol diacrylate.

In any aspect of the radiation curable ink composition for ink jet, the polymerizable compound may include a polyfunctional polymerizable compound, the polyfunctional polymerizable compound may include a tri- or higher functional polymerizable compound, and the tri- or higher functional polymerizable compound may include any one or more selected from trimethylolpropane triacrylate, ethylene oxide-modified trimethylolpropane triacrylate, and dipentaerythritol hexaacrylate.

In any aspect of the radiation curable ink composition for ink jet, the radiation curable ink composition for ink jet may be a black ink or a yellow ink.

The present disclosure is not limited to the above-described embodiment, and various modifications are possible. For example, the present disclosure includes a configuration substantially the same as the configuration described in the embodiment, for example, a configuration having the same function, method, and result, or a configuration having the same object and effect. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a publicly known technology is added to the configurations described in the embodiments.

What is claimed is:

1. A radiation curable ink composition for ink jet, comprising:
a polymerizable compound; and
a photopolymerization initiator, wherein
the photopolymerization initiator includes (2,4,6-trimethylbenzoyl)bis(p-tolyl)phosphine oxide,
a content of the (2,4,6-trimethylbenzoyl)bis(p-tolyl)phosphine oxide is 38 by mass or more with respect to a total amount of the ink composition,
the polymerizable compound includes a monofunctional polymerizable compound, and
a content of the monofunctional polymerizable compound is 70% by mass or more with respect to a total amount of the polymerizable compound.

2. The radiation curable ink composition for ink jet according to claim 1, wherein
the content of the monofunctional polymerizable compound is 85% by mass or more with respect to the total amount of the polymerizable compound.

3. The radiation curable ink composition for ink jet according to claim 1, wherein
the monofunctional polymerizable compound includes a nitrogen-containing monofunctional polymerizable compound.

4. The radiation curable ink composition for ink jet according to claim 1, wherein
the monofunctional polymerizable compound includes a hydroxyl group-containing monofunctional polymerizable compound.

5. The radiation curable ink composition for ink jet according to claim 1, wherein
the monofunctional polymerizable compound includes a saturated hydrocarbon ring-containing monofunctional polymerizable compound.

6. The radiation curable ink composition for ink jet according to claim 1, wherein
the monofunctional polymerizable compound includes an ether ring-containing monofunctional polymerizable compound.

7. The radiation curable ink composition for ink jet according to claim 1, wherein
the monofunctional polymerizable compound includes an aromatic group-containing monofunctional polymerizable compound.

8. The radiation curable ink composition for ink jet according to claim 1, further comprising:
a polymerization inhibitor, wherein
the polymerization inhibitor includes any one or more selected from bis(2,2,6,6-tetramethyl-4-piperidyl-1-oxyl) sebacate and 2,2,6,6-tetramethyl-4-hydroxypiperidin-1-oxyl.

9. The radiation curable ink composition for ink jet according to claim 1, further comprising:
a fluorescent whitening agent.

10. The radiation curable ink composition for ink jet according to claim 1, wherein
the polymerizable compound includes a polyfunctional polymerizable compound, and
the polyfunctional polymerizable compound includes a difunctional polymerizable compound.

11. The radiation curable ink composition for ink jet according to claim 10, wherein
the difunctional polymerizable compound includes a polymerizable compound represented by Formula (1): 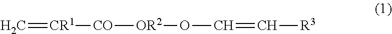
in Formula (1), R¹ is a hydrogen atom or a methyl group, R² is a divalent organic residue having 2 to 20 carbon atoms, and R³ is a hydrogen atom or a monovalent organic residue having 1 to 11 carbon atoms.

12. The radiation curable ink composition for ink jet according to claim 10, wherein
the difunctional polymerizable compound includes any one or more selected from 1,6-hexanediol diacrylate, dipropylene glycol diacrylate, and tripropylene glycol diacrylate.

13. The radiation curable ink composition for ink jet according to claim 1, wherein
the polymerizable compound includes a polyfunctional polymerizable compound,
the polyfunctional polymerizable compound includes a tri- or higher functional polymerizable compound, and
the tri- or higher functional polymerizable compound includes any one or more selected from trimethylolpropane triacrylate, ethylene oxide-modified trimethylolpropane triacrylate, and dipentaerythritol hexaacrylate.

14. The radiation curable ink composition for ink jet according to claim 1, wherein
the radiation curable ink composition for ink jet is a black ink or a yellow ink.
